(19) United States
(12) Patent Application Publication
(10) Pub. No.: US 2006/0139430 A1
(43) Pub. Date: Jun. 29, 2006

(54) Sheet feeding device and image recording apparatus equipped with the sheet feeding device

(75) Inventors: Masatoshi Izuchi, Aichi-ken (JP); Yuji Koga, Aichi-ken (JP); Noritsugu Ito, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/317,205

(22) Filed: Dec. 27, 2005

(30) Foreign Application Priority Data
Dec. 27, 2004 (JP) 2004-376508
Jan. 26, 2005 (JP) 2005-018127

(51) Int. Cl. B41J 13/076; B41J 2/01

(52) U.S. Cl. 347/104; 400/641; 400/636

(57) ABSTRACT

A sheet feeding device including: a sheet-feed roller driven by a drive source; and a spur roller which is opposed to a portion of the sheet-feed roller in an axial direction thereof and which is to be biased toward the sheet-feed roller, the spur roller and the sheet-feed roller cooperating with each other to feed a sheet while holding the sheet therebetween. In the sheet feeding device, the spur roller includes two spurs and an intermediate hub disposed between the two spurs for defining a distance therebetween and having an outside diameter smaller than that of each of the two spurs. Further, the sheet-feed roller includes: a large-diameter portion opposed to the intermediate hub so as to be interposable between respective radially outer portions of the two spurs; and two small-diameter portions which are respectively located on axially opposite sides of the large-diameter portion so as to extend beyond respective outer axial end faces of the two spurs and each of which has an outside diameter smaller than that of the large-diameter portion.

The present application is based on Japanese Patent Application Nos. 2004-376508 filed on Dec. 27, 2004 and 2005-018127 filed on Jan. 26, 2005, the contents of which are incorporated herein by reference.

### BACKGROUND OF THE INVENTION

1. Field of the Invention

The present invention relates in general to a sheet feeding device for feeding a sheet by cooperative action of a sheet-feed roller to be rotatably driven and at least one of spur rollers disposed to face the circumferential surface of the sheet-feed roller. The invention also relates to an image recording apparatus equipped with such a sheet feeding device.

2. Discussion of Related Art

A sheet feeding device for feeding a sheet is conventionally employed in an image recording apparatus of an ink-jet type such as a printer, a facsimile machine or the like. In the sheet feeding device, it is desirable to feed the sheet without deteriorating the quality of images recorded on a surface of the sheet such as a recording medium to be fed. An ordinary structure of the sheet feeding device used on the image recording apparatus is disclosed in U.S. Pat. No. 5,961,234A corresponding to JP-A-10-167507, for instance. Described specifically, in the disclosed sheet feeding device, there are disposed, in a sheet-feed path through which the sheet is fed, a sheet-feed roller and a plurality of spur rollers which are spaced apart from each other in the axial direction of the sheet-feed roller so as to face the circumferential surface of the sheet-feed roller. More specifically explained, each of the plurality of spur rollers has one spur. The spurs of the spur rollers are respectively opposed to annular grooves formed in the sheet-feed roller so as to be axially spaced apart from each other, and a radially outer toothed portion of each spur is inserted into the corresponding groove. In the thus constructed sheet feeding device, the sheet is fed while being held by and between the plurality of spur rollers and the sheet-feed roller.

### SUMMARY OF THE INVENTION

The sheet feeding device constructed as described above, however, encounters difficulty in optimizing relationship between: an amount of deflection of the sheet held by each spur roller and the sheet-feed roller, into the corresponding annular groove; and a sheet feeding force that depends on the deflection of the sheet. Such difficulty is one example of problems experienced in the conventional sheet feeding device and various other problems are found in the conventional sheet feeding device. Accordingly, the conventional sheet feeding device has much room for improvement in its utility. The present invention has been developed in view of such situations. It is therefore an object of the invention to provide a sheet feeding device with high utility and an image recording apparatus whose utility is improved owing to installation of such a sheet feeding device.

The above-indicated object of the present invention may be achieved according to one aspect of the invention, which provides a sheet feeding device comprising: a sheet-feed roller driven by a drive source; and a spur roller which is opposed to a portion of the sheet-feed roller in an axial direction thereof and which is to be biased toward the sheet-feed roller, the spur roller and the sheet-feed roller cooperating with each other to feed a sheet while holding the sheet therebetween. In the sheet feeding device, the spur roller includes two spurs and an intermediate hub disposed between the two spurs for defining a distance therebetween and having an outside diameter smaller than that of each of the two spurs, and the sheet-feed roller includes: a large-diameter portion opposed to the intermediate hub so as to be interposable between respective radially outer portions of the two spurs; and two small-diameter portions which are respectively located on axially opposite sides of the large-diameter portion so as to extend beyond respective outer axial end faces of the two spurs and each of which has an outside diameter smaller than that of the large-diameter portion.

In the sheet feeding device constructed as described above, the spur roller is displaced or shifted, against a biasing force, by a resistance force of the sheet to the deflection, i.e., by resilience of the sheet. In this instance, the sheet is deflected or flexed into a convex curved configuration toward the spur roller between the radially outer portions (radially outermost ends) of the two spurs of the spur roller. Namely, in the sheet feeding device constructed as described above, the deflection of the sheet can be easily optimized, thereby generating appropriate tension (a reaction force with respect to the deflection) in the sheet. Consequently, the present sheet feeding device is capable of feeding the sheet with a suitable feeding force.

In a first preferred form of the present sheet feeding device, the two small-diameter portions are two annular groove portions into which the respective two spurs are insertable.

According to the first preferred form indicated above, the sheet is deflected or flexed into a convex curved configuration toward the spur roller between the radially outer portions (radially outermost ends) of the two spurs of the spur roller while the sheet is deflected or flexed into a convex curved configuration toward the sheet-feed roller at portions thereof corresponding to the two annular groove portions of the sheet-feed roller each as the small-diameter portion. This arrangement further facilitates optimization of the deflection of the sheet, generating further appropriate tension in the sheet. Therefore, the sheet can be fed with a suitable feeding force.

In a second preferred form of the present sheet feeding device, a clearance between each of axial end faces of the large-diameter portion and each of axial inner end faces of the respective two spurs is not greater than 1 mm.

According to the second preferred form indicated above, it is possible to reduce the deflection amount of the sheet between the radially outer portions of the respective two spurs of the spur roller and the circumferential surface of the large-diameter portion of the sheet-feed roller when the sheet held by and between the sheet-feed roller and the spur roller is fed therebetween.

Where the above-indicated second preferred form is arranged such that the large-diameter portion has a width dimension as measured in an axial direction thereof that is not greater than 2 mm, the sheet feeding force can be enhanced while optimizing the deflection amount of the sheet held by the two spurs and the large-diameter portion.

In a third preferred from of the present sheet feeding device, radially outermost ends of the respective two spurs are out of contact with the respective two small-diameter portions.

According to the third preferred form indicated above, the radially outermost ends of the respective two spurs of the spur roller are out of contact with the sheet-feed roller irrespective of presence or absence of the sheet between the spur roller and the sheet-feed roller. Therefore, even where each spur is provided with sharp projections at its radially outermost end, such projections are less likely to be worn, resulting in improved durability of the spur.

The above-indicated third preferred form may be embodied with the following two mode: In a first mode, when the sheet is not present between the sheet feed roller and the spur roller, a circumferential surface of the large-diameter portion makes contact with a circumferential surface of the intermediate hub. In a second mode, the two small-diameter portions are two annular groove portions into which the respective two spurs are insertable and the sheet feed roller includes two circumferential portions between which the two annular groove portions and the large-diameter portion are provided. Further, in the second mode, the spur roller includes two side hubs between which the two spurs and the intermediate hub are provided, and when the sheet is not present between the sheet feed roller and the spur roller, circumferential surfaces of the respective two circumferential portions make contact with circumferential surfaces of the respective two side hubs.

According to those two modes, the spur roller is displaced by the large-diameter portion or the two circumferential portions of the sheet-feed roller, thereby reducing an amount of insertion of the radially outer portion of each spur into the corresponding small-diameter portion as measured from the circumferential surface of the large-diameter portion when the sheet is not held between the sheet-feed roller and the spur roller. Namely, an overlap amount by which the radially outer portion of each spur overlaps the large-diameter portion can be reduced. Therefore, it is possible to reduce a resistance force of the spur roller with respect to a force that displaces the spur roller, namely, a force required to displace the spur roller upon entering of the leading end of the sheet between the sheet-feed roller and the spur roller. As a result, the sheet feeding device with good sheet feeding accuracy is realized. In this connection, where the sheet feeding device according to either of those two modes is installed on an image recording apparatus, resistance to the sheet during feeding is prevented from increasing, thereby avoiding formation of extraneous lines in the image printed on the recording surface of the sheet (so-called banding) due to a variation in the line feed pitch. Thus, the image quality deterioration is effectively avoided.

In a case where the overlap amount between the sheet-feed roller and the radially outer portion (toothed portion) of the spur is relatively large, the leading end of the sheet fed toward the sheet-feed roller and the spur roller makes contact with radially inner portions of the spurs, disturbing smooth rotation of the spurs. In this instance, the sheet does not readily enter between the sheet-feed roller and the spurs, causing a risk of jamming of the sheet. The above-indicated two modes can easily deal with such a drawback.

The above-indicated object of the present invention may be achieved according to another aspect of the invention, which provides an image recording apparatus comprising: an image recording unit of an ink-jet type for recording an image on a sheet to be fed; and a sheet feeding device which is constructed according to the above-indicated one aspect and any of the preferred forms thereof and which is disposed on a downstream side of the image recording unit as seen in a sheet feed direction in which the sheet is to be fed, for feeding the sheet in the sheet feed direction.

The image recording apparatus equipped with the sheet-feeding device enjoys the aforementioned advantages obtained by the sheet feeding device. The image recording apparatus is advantageous in particular when the images with high dot density such as photographic images are recorded on the sheet. In this case, the sheet may get wet due to the ink attached thereto for recording such images with high dot density and may suffer from low resiliency (namely, a low resistance force to the deflection), leading to a decrease in the sheet feeding force. The decrease in the sheet feeding force may undesirably cause shortage of a sheet feed amount for every predetermined time and accordingly may result in occurrence of the banding. The present image recording apparatus, however, is free from a decrease in the sheet feeding force for feeding the sheet held by the sheet-feed roller and the spur roller and assures reliable feeding of the sheet in the sheet feed direction, whereby the occurrence of the banding can be avoided.

The present image recording apparatus can employ the above-indicated various forms relating to the sheet feeding device. For instance, where the image recording apparatus employs the form which prevents the wear of the projections provided at the radially outermost end of each spur, it is possible to prevent formation of impression on the recording surface of the sheet which would be caused by the worn projections of the spur and to avoid deterioration of the image quality due to transfer of the ink adhering to the worn projections back toward the recording surface of the sheet.

### BRIEF DESCRIPTION OF THE DRAWINGS

The above and other objects, features, advantages and technical and industrial significance of the present invention will be better understood by reading a following detailed description of preferred embodiments of the invention, when considered in connection with the accompanying drawings, in which:

FIG. 1 is a perspective view showing an ink-jet type image recording apparatus equipped with a feeding device to which the principle of the invention is applied;

FIG. 2 is a side elevational view in cross section showing the apparatus of FIG. 1;

FIG. 3 is a plan view of the apparatus of FIG. 1 from which an image reading device is removed;

FIG. 4 is a cross sectional view taken along line 4-4 of FIG. 3;

FIG. 5 is a perspective view of the apparatus of FIG. 1 from which a carriage is removed;

FIG. 6 is a fragmentary front elevational view partly in cross section showing a sheet-discharge roller and spur rollers according to a first embodiment of the invention:

FIG. 7 is a side elevational view of the spur roller;

FIG. 8 is a view explaining a state in which a sheet P is held by and between the sheet-discharge roller and the spur roller;

FIG. 9 is a table showing data of experimental results;

FIG. 10 is a graph showing experimental data in which the abscissa represents reaction force and the ordinate represents deflection amount, using, as parameters, width dimension W of an annular protruding portion of the sheet-discharge roller and clearance C between each of axial end faces of the annular protruding portion and each of axial inner end faces of adjacent two spurs of the spur roller;

FIG. 11 is a graph showing experimental data in which the abscissa represents width dimension W and the ordinate represents reaction force, using clearance C as a parameter;

FIG. 12 is a graph showing experimental data in which the abscissa represents clearance C and the ordinate represents reaction force, using width dimension W as a parameter;

FIG. 13 is a fragmentary front elevational view partly in cross section showing the sheet-discharge roller and a spur roller according to a second embodiment:

FIG. 14 is a fragmentary front elevational view partly in cross section showing the sheet-discharge roller and a spur roller according to a third embodiment:

FIG. 15 is a fragmentary front elevational view showing the sheet-discharge roller and a spur roller according to a fourth embodiment:

FIG. 16A is a front elevational view showing a spur roller according to a fifth embodiment;

FIG. 16B is a front elevational view showing a spur roller according to a sixth embodiment; and

FIG. 17 is a fragmentary front elevational view partly in cross section corresponding to FIG. 6, the view showing the sheet-discharge roller and spur rollers according to a seventh embodiment.

### DETAILED DESCRIPTION OF THE INVENTION

Referring to the drawings, there will be explained an image recording apparatus of an ink-jet type equipped with a feeding device to which the principle of the present invention is applied.

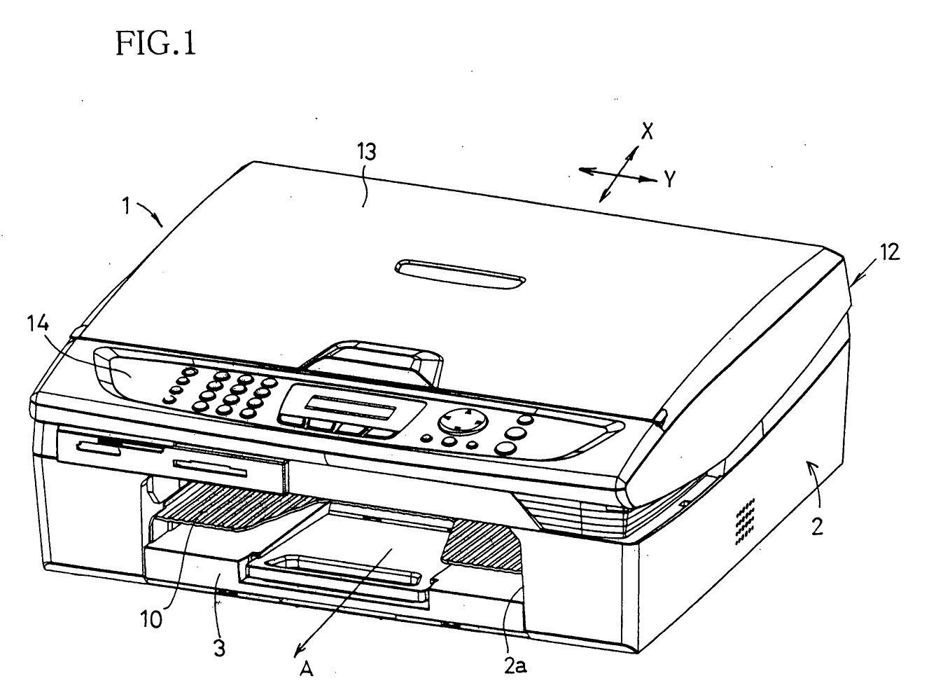

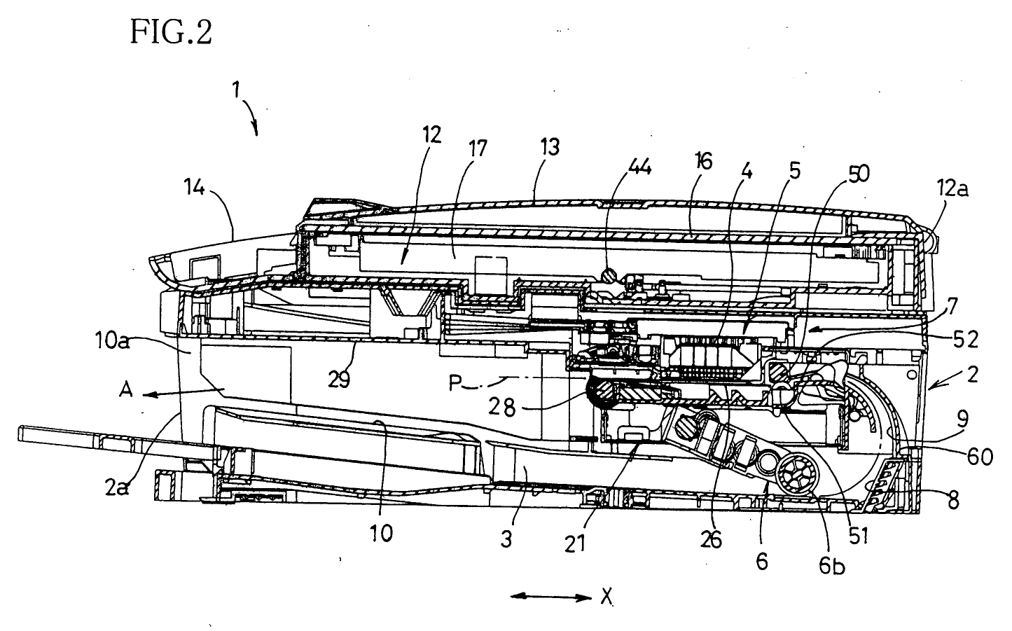

FIGS. 1 and 2 show the image recording apparatus 1 in the form of a multi-function device (MFD) which has a printing function, a copying function, a scanning function and a facsimile function. As shown in FIGS. 1 and 2, the image recording apparatus 1 has a housing 2 as a main body of the apparatus 1. The housing 2 is formed by injection-molding of a synthetic resin material.

On an upper portion of the housing 2, there is disposed an image reading device 12 which operates in the copying function and the facsimile function of the apparatus 1. The image reading device 12 is arranged to be pivotable upwards and downwards about one end of the housing 2 via a hinge device not shown. An original (manuscript) covering member 13 covering an upper surface of the image reading device 12 is pivotally connected at its rear end to a rear end of the image reading device 12 through hinges 12a such that the original covering member 13 is pivotable upwards and downwards about the hinges 12a.

Further, on the upper portion of the housing 2, there is provided an operator's control panel 14 located on a front side of the image reading device 12 and having various control buttons and keys, a liquid crystal display, etc. On the upper surface of the image reading device 12, there is provided a glass plate 16 on which an original or manuscript is to be placed when the original covering member 13 is opened upwards. Below the grass plate 16, an image scanning device (CIS: Contact Image Sensor) for reading the image on the original is provided so as to be reciprocably movable along a guide shaft 44 that extends in a direction perpendicular to a sheet plane of FIG. 2 (i.e., a main scanning direction, that is, in a Y-axis direction indicated in FIG. 1).

In an ink storage portion not shown, there are stored four ink cartridges accommodating inks of mutually different four colors, namely, black (Bk), cyan (C), magenta (M) and yellow (Y). The ink cartridges are normally connected to a recording head 4 of a recording portion (an image recording unit) 7 through respective flexible ink supply tubes.

As shown in FIGS. 1 and 2, there is disposed, on a lower or bottom portion of the housing 2, a sheet-supply cassette 3 that can be inserted through a front opening 2a located on the front side of the housing 2 (i.e., on the left side in FIG. 2). The sheet-supply cassette 3 is arranged to accommodate sheets to be fed in the form of a stack of cut sheets P of a selected size such as an A4 size, a letter size, a legal size or a postcard size, such that the width direction of each cut sheet P parallel to its two parallel short sides extends in a direction (i.e., the direction perpendicular to the sheet plane of FIG. 2, the main scanning direction, or the Y-axis direction) perpendicular to a sheet feed direction in which the sheets are fed (i.e., a sub-scanning direction, an X-axis direction or a direction indicated by an arrow X shown in FIGS. 1 and 2). The sheet feed direction is indicated by an arrow “A” in FIGS. 1, 3 and 5.

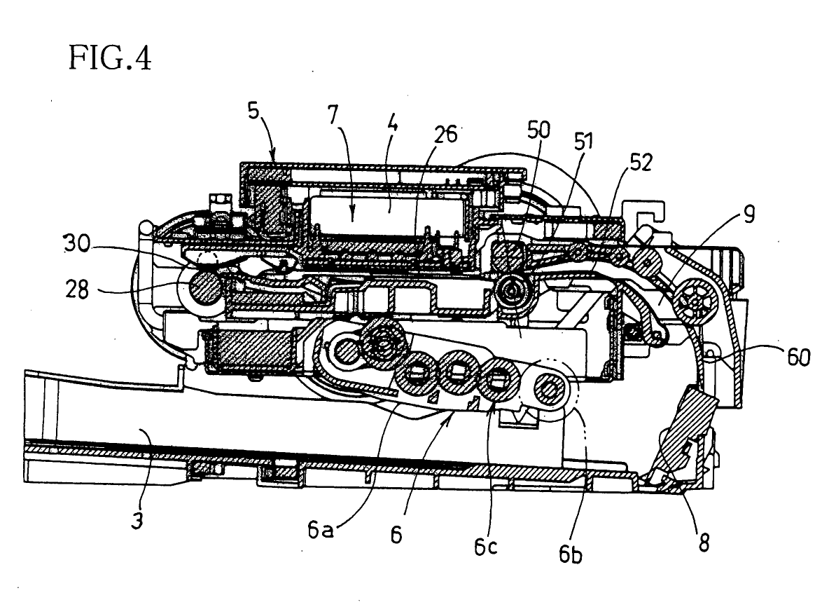

At one of opposite ends of the sheet-supply cassette 3 remote from the front opening 2a of the housing 2 (i.e., on the right side in FIG. 2), there is disposed an inclined sheet separator plate 8. Further, as shown in FIG. 4, a roller support arm 6a of a sheet supplying device is supported at its proximal end (upper end) by the housing 2 such that the roller support arm 6a is pivotable upwards and downwards. The roller support arm 6a carries at its free end (lower end) a sheet supply roller 6b to which a rotary motion from a drive source (not shown) is transmitted through a gear transmission mechanism disposed in the roller support arm 6a. The sheet-supply roller 6b and the inclined sheet separator plate 8 cooperate with each other to separate the uppermost sheet P from the stack accommodated in the sheet-supply cassette 3 and feed the separated sheet P toward the recording portion 7 located above the sheet-supply cassette 3, via a sheet-supply path 9 including a substantially U-turn path portion. The sheet-supply path 9 is given by a space that is defined between a first supply-path-defining member 60 located at a radially outer portion of the U-turn path portion of the sheet-supply path 9 and a second supply-path defining member 52 located at a radially inner portion of the U-turn path portion of the same 9. Each sheet P is arranged to be fed through the sheet-supply path 9 such that a centerline of the sheet P in its widthwise direction is aligned with a centerline of the sheet-supply path 9 in its widthwise direction perpendicular to the sheet feed direction A.

As shown in FIGS. 2-5, the recording portion 7 is supported by a main frame 21 of box structure which includes a pair of side walls 21a, 21a, and is disposed between a first guide member 22 and a second guide member 23 each in the form of an elongate plate. The first and second guide members 22, 23 are supported by the side plates 21a and extend in the Y-axis direction (the main scanning direction). A carriage 5 which carries the ink-jet recording head 4 of the recording portion 7 is mounted on the first guide member 22 located upstream of the carriage 5 in the sheet feed direction A and the second guide member 23 located downstream of the carriage 5 in the sheet feed direction A, so as to bridge these two guide members 22, 23, such that the carriage 5 is slidably movable on the guide members 22, 23. Thus, the carriage 5 is reciprocably movable in the Y-axis direction.

For reciprocably moving the carriage 5, there is disposed, on an upper surface of the second guide member 23, a timing belt 24 which extends in the main scanning direction (the Y-axis direction). Further, a carriage drive motor (not shown) operable to reciprocate the carriage 5 through the timing belt 24 is fixed to a lower surface of the second guide member 23.

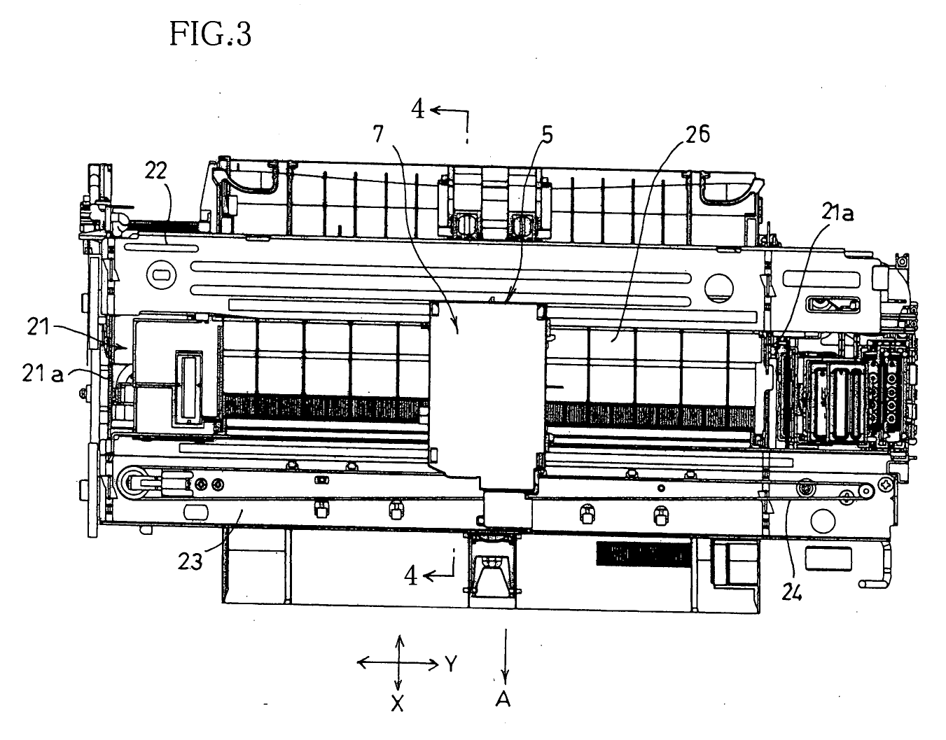

As shown in FIG. 3, a platen 26 having a flattened shape is fixed to the main frame 21 between the first and second guide members 22, 23. The platen 26 extends in the Y-axis direction so as to face an underside of the recording head 4 carried by the carriage 5.

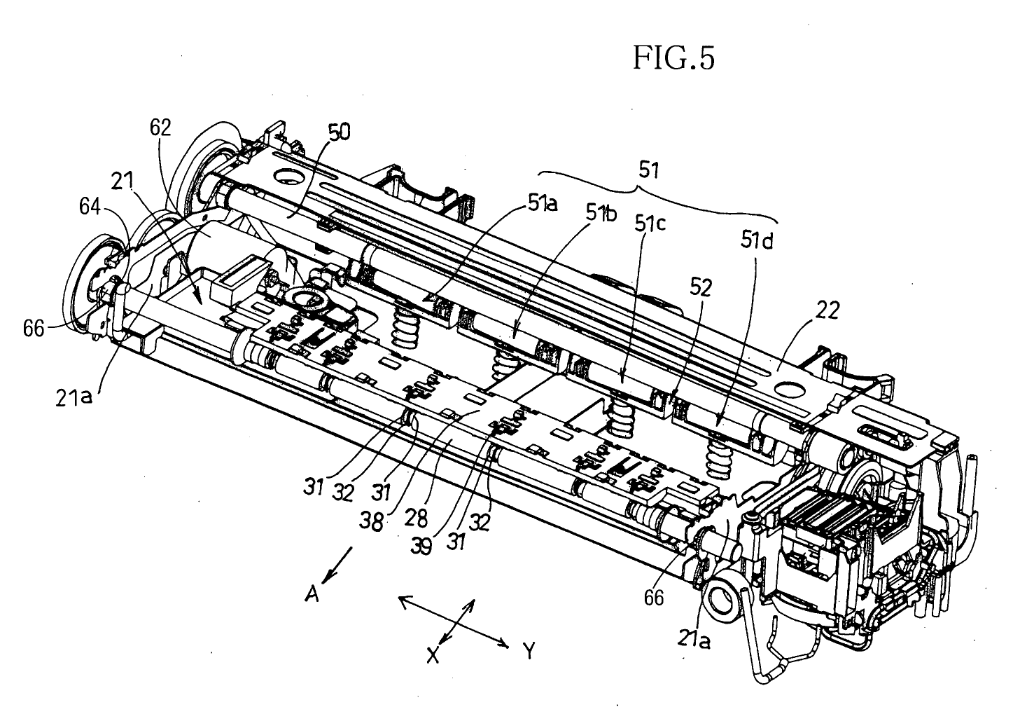

On an upstream side of the platen 26 as viewed in the sheet feed direction A, there are disposed, as registering rollers for feeding the sheet P to the underside of the recording head 4, a drive roller 50 and nip rollers 51a-51d which are disposed below the drive roller 50 so as to face the same 50, as shown in FIGS. 4 and 5. On a downstream side of the platen 26 as viewed in the sheet feed direction A, there are disposed a sheet-discharge roller 28 as a sheet-feed roller that is driven to feed the sheet P which has passed through the recording portion 7 in the sheet feed direction A toward a sheet-discharge portion 10, and a plurality of spur rollers 30 (six spur rollers in this embodiment) which are disposed over the sheet-discharge roller 28 so as to face the same 28 and which are to be biased toward the sheet-discharge roller 28. The feeding device according to the present invention is constituted by including the sheet-discharge rollers 28, the spur rollers 30, a line feed motor 62 for driving the sheet-discharge roller 28, etc.

The sheet P on which the recording operation by the recording portion 7 has been performed is discharged into the sheet-discharge portion 10, with the recorded surface of the sheet P facing upwards. The sheet-discharge portion 10 is located above the sheet-supply cassette 3, and a sheet-discharge opening 10a communicating with the sheet-discharge portion 10 is open on the front side of the housing 2 so as to be in common with the front opening 2a of the housing 2. Further, a partition plate (lower covering member) 29 made of a synthetic resin and formed integrally with the housing 2 is provided to extend from a lower surface of the second guide member 23 to the front end of the housing 2 where the sheet-discharge opening 10a is open, so as to cover the sheet-discharge portion 10 on its upper side, as shown in FIG. 2.

Next, there will be explained in detail a sheet holding structure by a cooperative action of the sheet-discharge roller 28 and the spur rollers 30 for holding the sheet P therebetween, according to a first embodiment.

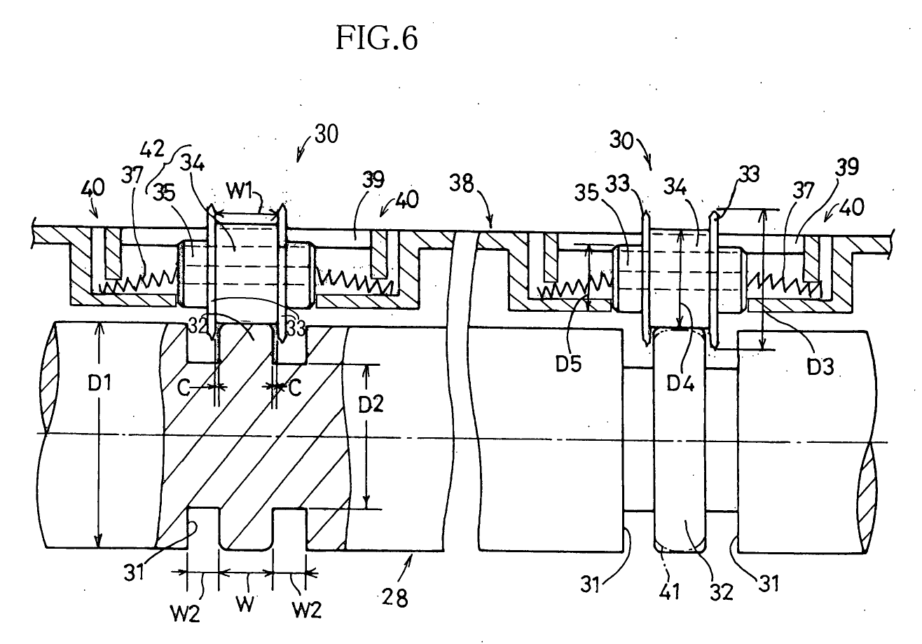

As shown in FIGS. 5 and 6, the sheet-discharge roller 28 has a cylindrical shape having a diameter D1 and extending in the direction (the Y-axis direction or the widthwise direction of the sheet P) perpendicular to the sheet feed direction A. The sheet-discharge roller 28 is supported at its opposite axial ends by the respective side plates 21a of the main frame 21 and is rotatably driven by a drive force transmitted from the line feed motor 62. Described more specifically referring to FIG. 5, the sheet-discharge roller 28 is rotatably supported at its opposite axial ends by the respective side plates 21a through respective bearings 66 which are fixed to the corresponding side plates 21. Further, a gear for transmitting the drive force from the line feed motor 62 to the sheet-discharge roller 28 is fixed to one axial end of the sheet-discharge roller 28. One of the side plates 21 and one of the bearings 66 which correspond to the above-indicated one axial end of the sheet-discharge roller 28 are sandwiched by and between the gear and a fixing ring 64 that is mounted on the sheet-discharge roller 28, whereby the sheet-discharge roller 28 is positioned in the widthwise direction of the sheet P. The sheet-discharge roller 28 is made of a metal and is subjected at its cylindrical surface to a treatment for increasing a friction force by coating the cylindrical surface with ceramic particles or attaching a thin resin film having a high degree of coefficient of friction such as a rubber, for instance. The sheet-discharge roller 28 includes several pairs of annular groove portions 31 and annular protruding portions 32 each of which is interposed between two annular groove portions 31 of each pair. The several pairs of annular groove portions 31 are spaced apart from each other by a predetermined distance in the widthwise direction of the sheet P and the two annular groove portions 31 of each pair has a diameter D2 smaller than the diameter D1 of the sheet-discharge roller 28 (D2<D1). Each annular groove portion 31 serves as a small-diameter portion while each annular protruding portion 32 serves as a large-diameter portion.

As shown in FIG. 6, each spur roller 30 is disposed so as to be opposed to a portion of the sheet-feed roller 28 in its axial direction corresponding to each pair of annular groove portions 31 and the annular protruding portion 32 interposed between the two annular groove portions 31 of each pair. The spur roller 30 includes two spurs 33 each having a diameter D3 and a hub portion 42 connecting the two spurs 33 and formed of a synthetic resin. The hub portion 42 includes: a cylindrical intermediate hub 34 which has a diameter D4 and which connects inner axial end faces of the respective two spurs 33 at radially inner portions thereof, and two cylindrical side hubs 35 which have a diameter D5 and each of which is connected to a radially inner portion of an outer axial end face of the corresponding one of the two spurs 33. In this first embodiment, the diameter D4 of the intermediate hub 34 is larger than the diameter D5 of the side hubs 35. In the present invention, the respective diameters D3, D4, D5 of the spurs 33, the intermediate hub 34 and the side hubs 35 are set to be D3>D4≧D5.

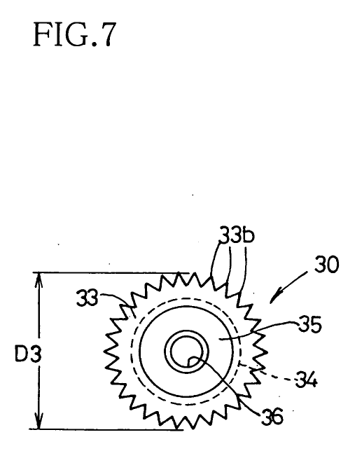

As shown in FIG. 7, each spur 33 is a disc-like member made of metal and has a multiplicity of projections 33b formed at its radially outermost end continuously along its circumference. Each projection 33b has a generally triangular shape in side view with a sharp or acute tip. A through-hole 36 is formed through respective central portions of the intermediate hub 34, side hubs 35 and two spurs 33 of each spur roller 30 so as to extend in the axial direction of the spur roller 30. An elastic shaft 37 (as an elastic member) made of a coil spring is inserted through the through-hole 36. According to this arrangement, each spur roller 30 is made rotatable about the corresponding elastic shaft 37 and displaceable in a direction intersecting its rotation axis by deflection of the elastic shaft 37.

A support plate 38 made of a resin and fixed at its opposite ends to the respective side plates 21a of the main frame 21 is disposed above the sheet-discharge roller 28 so as to be parallel with the same 28, as shown in FIGS. 5 and 6. The support plate 38 is formed with mounting holes 39 into which the plurality of spur rollers 30 are respectively received. At opposite ends of each mounting hole 39 as seen in the axial direction of the spur roller 30, there are provided support portions 40 which respectively support opposite ends of the elastic shaft 37 so as to prevent the elastic shaft 37 from displacing in the upward direction. Further, the support portions 40 extend close to the respective side hubs 35 at lower parts thereof by which the elastic shaft 37 is supported at its underside while, at the same time, preventing the spur roller 30 from displacing in the axial direction, i.e., in the widthwise direction of the sheet P.

In a state in which the sheet P is not held or gripped by and between the sheet-discharge roller 28 and the spur rollers 30, each of the elastic shafts 37 which are provided for the respective spur rollers 30 is supported at its opposite ends by the support portions 40 such that the corresponding spur roller 30 is biased toward the sheet-discharge roller 28 by the elastic shaft 37, as shown in FIG. 6. In this instance, the pair of spurs 33 in each spur roller 30 are respectively inserted or received in the corresponding pair of annular groove portions 31 of the sheet-discharge roller 28, and the intermediate hub 34 of the spur roller 30 is held in abutting contact, at its circumferential surface, with the corresponding annular protruding portion 32 of the sheet-discharge roller 28. Thus, the sheet-discharge roller 28 is biased by the spur roller 30. In other words, the annular protruding portion 32 is inserted between the two spurs 33 so as to face the intermediate hub 34. In this arrangement, however, each spur 33 is configured not to abut, at its radially outermost end (the projections 33), on the inner surface of the corresponding annular groove portion 31. For this end, in this embodiment, the annular protruding portion 32 located between the pair of spurs 33 has a width dimension W as measured in its axial direction which is smaller than a width dimension W1 of the intermediate hub 34 as measured in its axial direction while each annular groove portion 31 has a width dimension W2 which is about ten times the thickness t1 of each spur 33, thereby forming a clearance C (FIG. 6) between each of axial end faces of the annular protruding portion 32 and each of axial inner end faces of the respective two spurs 33 confronting the corresponding axial end faces of the annular protruding portion 32. In this embodiment, the diameter D3 and the thickness t1 of each spur 33 is about 6 mm and about 0.1 mm, respectively. The diameter D4 of the intermediate hub 34 is about 4 mm, the diameter D1 of the sheet-discharge roller 28 is about 8.1 mm, and the diameter D2 of the annular groove portion 31 is about 5.5 mm. The width dimension W2 of the annular groove portion 31 is about 1.2 mm, the width dimension W of the annular protruding portion 32 (W=W1−2C) is not greater than 2 mm, and the clearance C is not greater than 1 mm. As described above, the respective diameters D3, D4, D5 of the spurs 33, the intermediate hub 34 and the side hubs 35 of each spur roller 30 are set to be D3>D4 D5. Where the diameter D4 of the intermediate hub 34 is equal to the diameter of D5 of the side hubs 35, the side hubs 35 abut on the sheet-discharge roller 28 as well as the intermediate hub 34.

In the arrangement described above, when the sheet P is not held by and between the sheet-discharge roller 28 and the spur rollers 30 which are biased toward the same 28, the spurs 33 of each spur roller 30 are out of contact, at radially outermost ends thereof, with any portion of the sheet-discharge roller 28 which is rotatably driven and to which the spur roller 30 is opposed. Therefore, the radially outermost sharp protrusions 33b of the spur 33 are less likely to be worn. More specifically described, the sharp protrusions 33b are prevented from being deformed, due to wear resulting from contact with the bottom of the annular groove portion 31 of the sheet-discharge roller 28, into a configuration which tends to cause transfer of the ink adhering thereto back to the recorded surface of the sheet P and a configuration which tends to form impression onto the recording surface of the sheet P as a result of reduction in the width of the sharp protrusions 33b due to contact with the side faces of the annular groove portions 31. Further, the circumferential surface of the intermediate hub 34 of each spur roller 30 abuts on the circumferential surface of the corresponding annular protruding portion 32 of the sheet-discharge roller 28, whereby the spur roller 30 is lifted up or raised. Accordingly, when the sheet P is not held by and between the sheet-discharge roller 28 and the spur rollers 30, it is possible to reduce an amount of insertion of each spur 33 into the corresponding annular groove portion 31, namely, an overlap amount by which the radially outermost end of each spur 33 overlaps the annular protruding portion 32. Owing to the reduction in the overlap amount, a force for raising the spur roller 30, i.e., a force required to raise the spur roller 30 upon entering of the leading end of the sheet P between the sheet-discharge roller 28 and the spur roller 30 can be reduced, thereby assuring smooth feeding of the sheet P. Therefore, the line feed pitch is not varied, so that the occurrence of the banding at the leading end of the sheet P can be avoided. Because the intermediate hub 34 of each spur roller 30 is held in abutting contact with the corresponding annular protruding portion 32 of the sheet-discharge roller 28, the spur roller 30 is rotated by rotation of the sheet-discharge roller 28. Accordingly, even when the leading end of the sheet P hits on the spur roller 30, the resistance to the sheet P entering between the sheet-discharge roller 28 and the spur roller 30 is reduced, whereby the sheet P can be smoothly fed.

In the image recording apparatus 1 constructed as described above, based on the image recoding command, the uppermost sheet P of the stack accommodated in the sheet-supply cassette 3 is advanced by rotation of the sheet-supply roller 6b so as to come into contact, at its leading end, with the inclined sheet separator plate 8, so that the sheet P is separated from the stack and then fed toward the sheet-supply path 9. The sheet P makes a U-turn upwardly along the sheet-supply path 9 and is fed on the platen 26 of the image recording portion 7 with its leading end held by and between the drive roller 50 and the nip rollers 51.

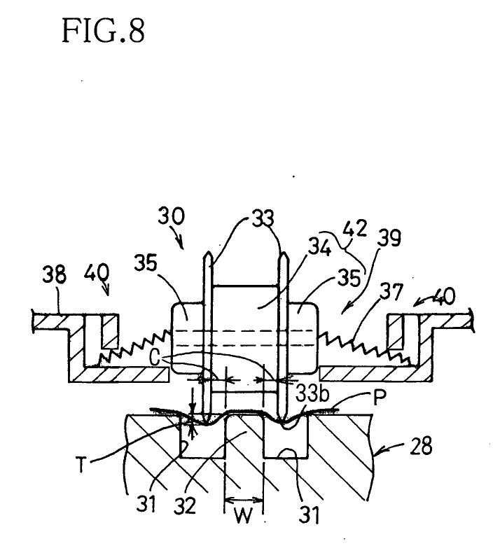

In a state wherein the sheet P on which images have been recorded as a result of passing through the image recording portion 7 is fed (discharged) between the sheet-discharge roller 28 and the plurality of spur rollers 30 while being held therebetween, each spur roller 30 is lifted up by a resistance force of the sheet P to deflection or flexure, i.e., by resilience of the sheet P, against the biasing force of the elastic shaft 37, as shown in FIG. 8. In this state, the sheet P is deflected or flexed into an upwardly convex curved configuration between the radially outermost ends (the projections 33b) of the two spurs of each spur roller 30 by the annular protruding portion 32 while the sheet P is deflected or flexed into a downwardly convex curved configuration at portions thereof corresponding to the annular groove portions 31 by the radially outermost ends (the projections 33b) of the respective two spurs 33 of each spur roller 30. Thus, there is generated, in the sheet P, tension (a reaction force with respect to the deflection), so that the sheet P can be fed in the sheet feed direction with a suitable feeding force.

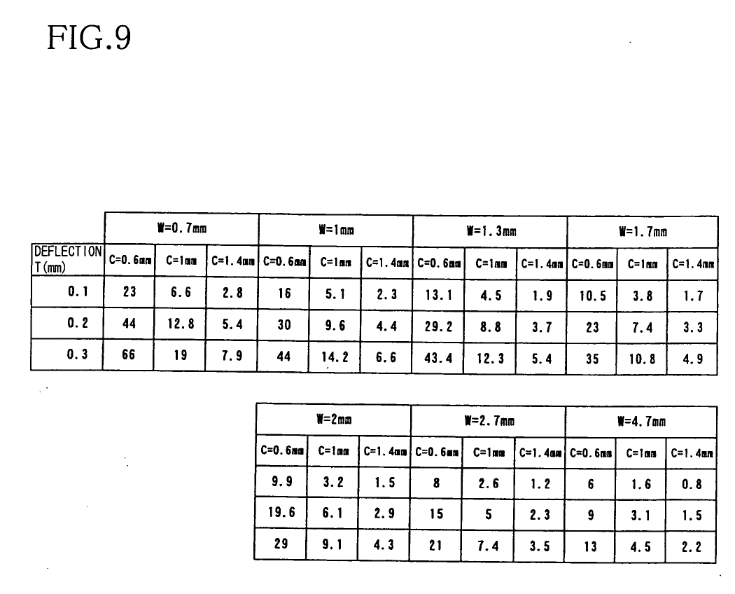

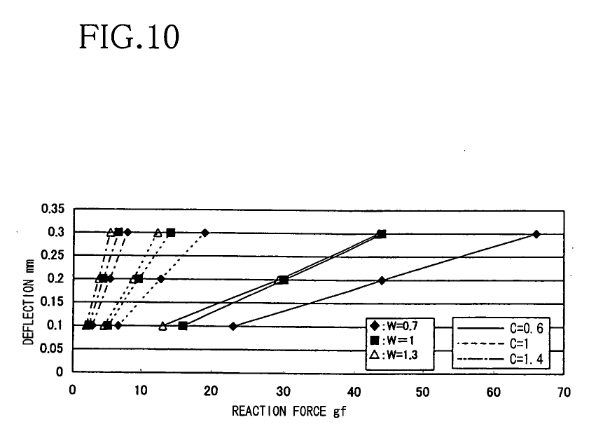

An amount T (mm) of deflection of the sheet P (shown in FIG. 8), that is, an amount by which the sheet P is deflected into each annular groove portion 31 by the biasing force of the elastic shaft 37 was measured by varying the width dimension W of the annular protruding portion 32 and the clearance C between each of the axial end faces of the annular protruding portion 32 and each of the axial inner end faces of the respective two spurs 33. The above-indicated deflection amount T of the sheet P may be considered as a distance between: a contact point of the sheet P and the radially outermost end (the projections 33b) of each spur 33; and a contact point of the sheet P and the circumferential surface of the annular protruding portion 32. In the measurement, the sheets P being fed (discharged) had mutually equal paper quality and images were recorded on the sheets P at the same recording density. The results of measurement are indicated in the table of FIG. 9. Based on the measured deflection amount T (mm), the reaction force (gf: gram-force) acting on one spur 33 was calculated according to a suitable formula (i.e., a relation between deflection of a beam simply supported at its opposite ends and supportive reaction force where concentrated load acts on two points of the beam intermediate between the opposite ends thereof). FIG. 10 is a graph in which the measured data is arranged and in which the abscissa represents the reaction force and the ordinate represents the deflection amount, using the width dimension W and the clearance C as parameters.

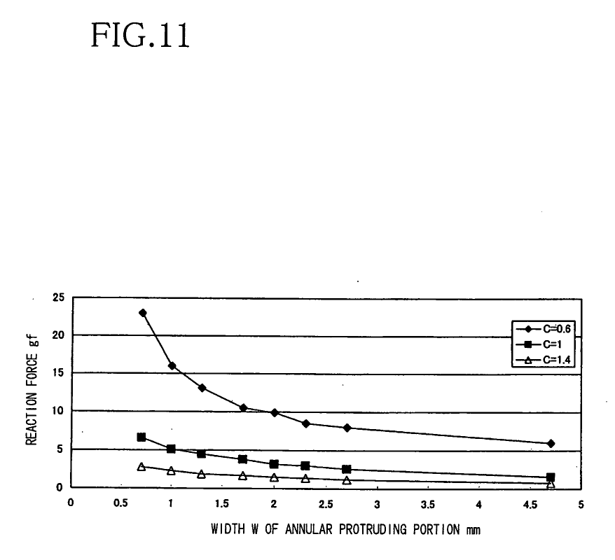

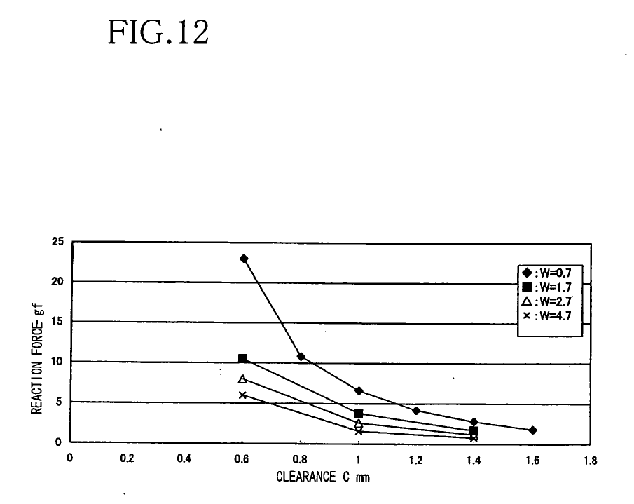

FIG. 11 is a graph in which the measured data is arranged and in which the abscissa represents the width dimension W of the annular protruding portion 32 and the ordinate represents the reaction force, using the clearance C as a parameter. FIG. 12 is a graph in which the measured data is arranged and in which the abscissa represents the clearance C and the ordinate represents the reaction force, using the width dimension W as a parameter.

It is apparent from the experimental results that, where the clearance C is large, the reaction force does not largely change and is small irrespective of a change in the width dimension W of the annular protruding portion 32. Where the clearance C is small (i.e., not larger than about 1 mm), on the other hand, the reaction force increases with a decrease in the width dimension W. In other words, by reducing the width dimension W of the annular protruding portion 32, a relatively large reaction force, namely, a relatively large feeding force can be obtained where the clearance C is small. Further, where the width dimension W of the annular protruding portion 32 exceeds 2.5 mm, the reaction force is small and remains on the small level.

From the experimental results indicated above, the following is recognized: In the arrangement described above, the intermediate hub 34 having a smaller diameter than the pair of spurs 33 is interposed between the spurs 33 of each spur roller 30, and the sheet-discharge roller 28 has the annular protruding portion 32 formed between the annular groove portions 31 into which the radially outer portions of the respective spurs 33 of each spur roller 30 are insertable. In this arrangement, by setting the above-indicated clearance C to not greater than 1 mm or setting the width dimension W of the annular protruding portion 32 to not greater than 2 mm, the following advantage is assured: If the sheet P to be used is plain paper, the sheet P may get wet due to the ink attached thereto upon recording of images with high dot density such as photograph images, whereby the sheet P may suffer from low resiliency, namely, a low resistance force to the deflection. In the present arrangement, however, even if the sheet P suffers from such low resiliency, the feeding force for feeding the sheet P while being held by and between the sheet-discharge roller 28 and each spur roller 30 is not lowered, so that the sheet P can be fed with high reliability. Therefore, it is possible to avoid the occurrence of the banding.

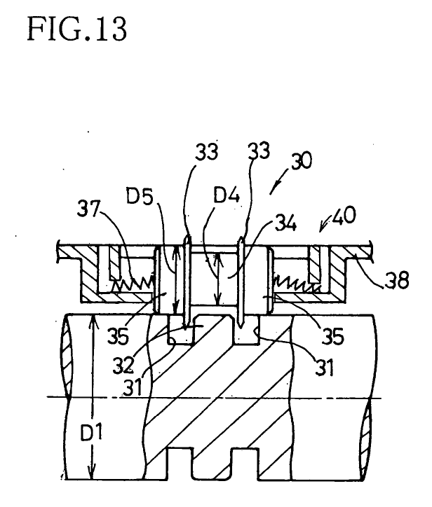

Referring next to FIG. 13, there will be described the sheet holding structure according to a second embodiment of the invention. As in the first embodiment, the radially outermost end of each spur 33 is out of contact with the sheet-discharge roller 28 when the sheet P is not held by and between the sheet-discharge roller 28 and the spur rollers 30. In this second embodiment, the diameter D5 of each of the side hubs 35 which are respectively provided axially outwardly of the two spurs 33 of each spur roller 30 is made larger than the diameter D4 of the intermediate hub 34. In this arrangement, therefore, when the sheet P is not held between the sheet-discharge roller 28 and the spur rollers 30, the circumferential surfaces of the side hubs 35 of each spur roller 30 respectively abut on circumferential surfaces of two circumferential portions of the sheet-discharge roller 28 which are respectively located axially outwardly of the corresponding two annular groove portions 31 of the sheet-discharge roller 28 and which have the diameter D1 while, at the same time, the circumferential surface of the intermediate hub 34 is out of contact with the circumferential surface of the annular protruding portion 32, namely, the intermediate hub 34 is radially spaced apart from the annular protruding portion 32 by a suitable spacing. This second embodiment differs from the illustrated first embodiment only in the structure of the side hubs 35, and its detailed explanation is dispensed with by using the same reference numerals as in the first embodiment to identify the corresponding components. As in the first embodiment, the radially outermost end of each spur 33 does not contact the inner surface of the corresponding annular groove portion 31, whereby the sharp projections 33b at the radially outermost end of the spur 33 do not suffer from wear. Accordingly, it is possible to prevent formation of the impression on the recording surface of the sheet P due to the worn projections 33b and avoid deterioration of the image quality due to the transfer of the ink adhering to the worn projections 33b back toward the recording surface of the sheet P, as explained above with respect to the illustrated first embodiment. Further, the amount of insertion of the radially outer portion of each spur 33 into the corresponding annular groove portion 31 (i.e., the overlap amount) can be reduced, as in the first embodiment. Owing to the reduction in the overlap amount, the force for raising the spur roller 30 upon entering of the leading end of the sheet P between the sheet-discharge roller 28 and the spur roller 30 can be reduced, thereby assuring smooth feeding of the sheet P. Therefore, it is possible to avoid the variation in the line feed pitch, so that the occurrence of the banding at the leading end of the sheet P can be prevented. Because the two side hubs 35 in each spur roller 30 are respectively held in abutting contact with the corresponding circumferential portions of the sheet-discharge roller 28 indicated above, the spur roller 30 is rotated by rotation of the sheet-discharge roller 28. Accordingly, even when the leading end of the sheet P hits on the spur roller 30, the resistance to the sheet P entering between the sheet-discharge roller 28 and the spur roller 30 is reduced, whereby the sheet P can be smoothly fed.

As shown in FIG. 6, the annular protruding portion 32 has rounded corner portions at each of which the circumferential surface and each of the axial end faces of the annular protruding portion 32 are connected. The circumferential surface of the annular protruding portion 32 may be formed into an axially convex curved surface 41 (may be referred to as “crown”) whose diameter is larger than that of the axial end faces, as indicated in two-dot chain line in FIG. 6. Where the circumferential surface of the annular protruding portion 32 is formed as described above, the sheet P is free of a risk of suffering from creasing which arises from folding of the sheet P at the corner portions of the annular protruding portion 32 when the sheet P held by and between the two spurs 33 of each spur roller 30 and the circumferential surface of the annular protruding portion 32 is fed therebetween. Therefore, the image quality is not deteriorated.

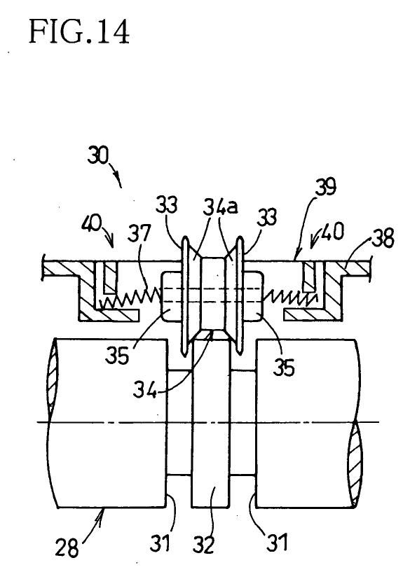

While the circumferential surface of the intermediate hub 34 in each spur roller 30 is given by a straight cylindrical surface in the illustrated first and second embodiments, the circumferential surface may be configured to have a pair of inclined portions as described with respect to the following third through sixth embodiments (FIGS. 14-16) in which the same reference numerals as used in the illustrated first embodiment are used to identify the corresponding components and a detailed explanation thereof is omitted in the interest of brevity.

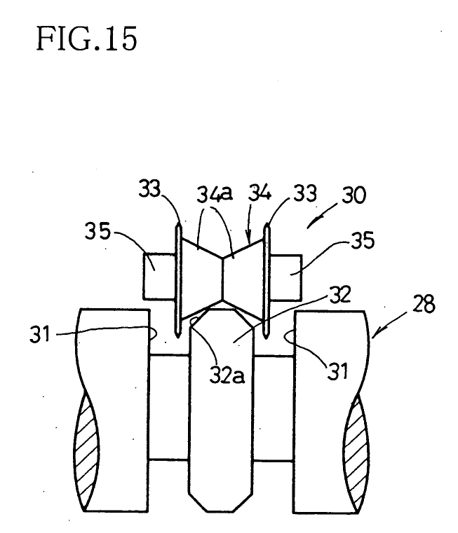

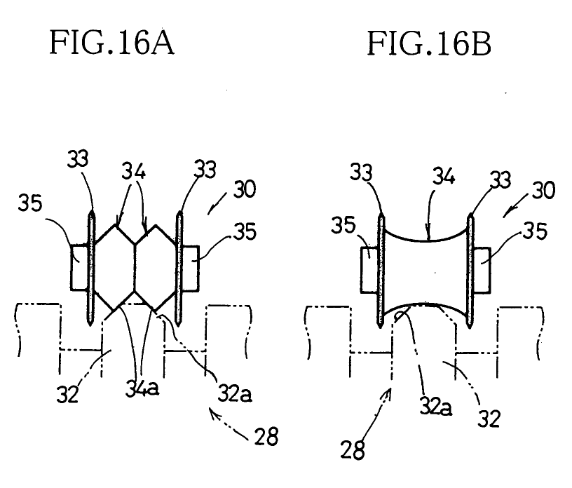

In the third embodiment shown in FIG. 14, the circumferential surface of the intermediate hub 34 disposed between the two spurs 33 in each spur roller 33 is formed to have a shape in which the diameter of the circumferential surface gradually decreases from the axially opposite ends of the intermediate hub 34 toward the axially middle cylindrical portion thereof. Thus, the intermediate hub 34 has the pair of inclined portions 34a. In the fourth embodiment shown in FIG. 15, the intermediate hub 34 has a configuration in which two truncated cones are connected to each other. Accordingly, the circumferential surface of the intermediate hub 34 is given by a combination of circumferential surfaces of the respective two truncated cones and has a diameter which lineally decreases from its axially opposite ends toward its axially middle portion. Thus, the intermediate hub 34 has the pair of inclined portions 34a. In the fifth embodiment shown in FIG. 16A, the intermediate hub 34 has a configuration in which four truncated cones are connected to each other. Accordingly, the intermediate hub 34 has the pair of inclined portions 34a at its axially middle portion. In the sixth embodiment shown in FIG. 16B, the circumferential surface of the intermediate hub 34 is formed to have a concave globoidal shape in which the diameter of the circumferential surface gradually and curvilinearly decreases from the axially opposite ends of the intermediate hub 34 toward the axially middle portion thereof. It is noted that the pair of inclined portions may be provided by respective flat surfaces or curved surfaces. In the fourth through sixth embodiments, the annular protruding portion 32 of the sheet-discharge roller 28 has chamfered corner portions 32a which are formed by chamfering the corners by about 45 degrees and at each of which the circumferential surface and each of the axial end faces of the annular protruding portion 32 are connected. As described above with respect to the first and second embodiments, the annular protruding portion 32 may have rounded corner portions or its circumferential surface may be formed into axially convex curved surface shown in FIG. 6. Like the rounded corner portions and the circumferential surface with the axially convex curved surface, the chamfered corner portions are effective to prevent the creasing of the sheet P at the corner portions as described above.

According to the illustrated third through sixth embodiments, when the trailing end of the sheet P comes out of the sheet-discharge roller 28 and the spur rollers 30, and then the two spurs 33 of each spur roller 30 which have been raised by the sheet P enter the corresponding two annular groove portions 31, the corner portions of the annular protruding portion 32 are brought into contact with the respective inclined portions 34a of the intermediate hub 34. Therefore, the above-indicated clearance C with a suitable dimension can be maintained with high reliability, thereby preventing chipping of the radially outermost projections 33b of each spur 33 due to collision with the circumferential surface of the annular protruding portion 32. Further, because the amount of the clearance C can be made equal on axially opposite sides of the annular protruding portion 32, namely, the two clearances C between the axial end faces of the annular protruding portion 32 and the corresponding axial inner end faces of the respective two spurs 33 can be made equal to each other, the feeding force for feeding the sheet P can be stabilized in the widthwise direction of the sheet P, preventing the sheet P from being fed obliquely with respect to the sheet feed direction. Moreover, the relative position of the sheet-discharge roller 28 and each spur roller 30 in the axial direction is restricted by contact of the inclined portions 34a and the annular protruding portion 32 even where any other means for restricting the relative position is not provided.

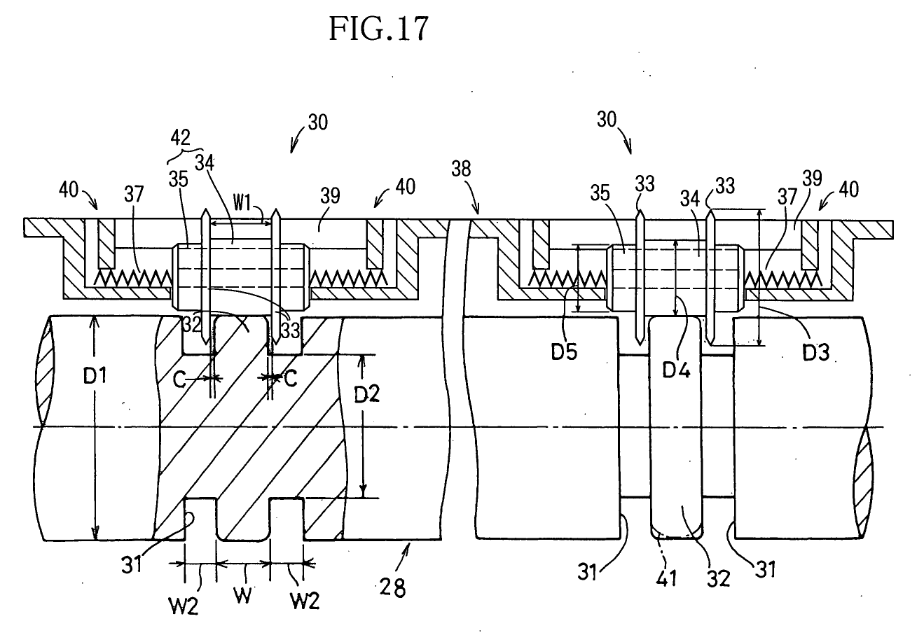

Referring next to FIG. 17, there will be explained the sheet holding structure according to a seventh embodiment of the invention. In the first through sixth embodiments illustrated above, the biasing force of the elastic shaft 37 provided for each spur roller 30 acts on the sheet-discharge roller 28, namely, the spur roller 30 is biased toward the sheet-discharge roller 28 by the elastic shaft 37 all the time irrespective of presence or absence of the sheet P therebetween. As described below, each spur roller 30 may not be biased toward the sheet-discharge roller 28 by the elastic shaft 37 when the sheet P is not present therebetween. In this seventh embodiment, the same reference numerals as used in the illustrated first embodiment shown in FIG. 6 are used to identify the corresponding components, and a detailed explanation of which is dispensed with.

In this seventh embodiment, when the sheet P is not present between the sheet-discharge roller 28 and the spur rollers 30, the elastic shaft 37 provided for each spur roller 30 is supported by the respective supporting portions 40 so as to extend in parallel with the axis of the sheet-discharge roller 28 as shown in FIG. 17, and the elastic shaft 37 does not bias the spur roller 30 toward the sheet-discharge roller 28 though the elastic shaft 37 receives the weight of the spur roller 30. Further, the intermediate hub 34 of each spur roller 30 and the annular protruding portion 32 are out of contact with each other with a slight spacing therebetween, and the sheet-discharge roller 28 is not biased by the spur roller 28. In this instance, the radially outer portions of the respective two spurs 33 of each spur roller 30 are inserted into the corresponding annular groove portions 31, but the radially outermost end of each of the two spurs 33 are out of contact with the inner surface of the annular groove portion 31. In other words, the alular protruding portion 32 is inserted between the two spurs 33 so as to be opposed to the intermediate hub 34. In this arrangement, however, each spur 33 is configured not to abut, at its radially outermost end (the projections 33), on the inner surface of the corresponding annular groove portion 31. For this end, the annular protruding portion 32 located between the pair of spurs 33 has a width dimension W as measured in its axial direction which is smaller than a width dimension W1 of the intermediate hub 34 as measured in its axial direction, and each annular groove portion 31 has a width dimension W2 which is about ten times the thickness t1 of each spur 33, whereby there is formed a clearance C (FIG. 17) between each of the axial end faces of the annular protruding portion 32 and each of the axial inner end faces of the respective two spurs 33 confronting the corresponding axial end faces of the annular protruding portion 32, as in the illustrated first embodiment of FIG. 6. Unlike the illustrated first embodiment, the diameter D4 of the intermediate hub 34 is about 3 mm. The diameter D3 and the thickness t1 of each spur 33, the respective diameters D1, D2 of the sheet-discharge roller 28 and the annular groove portion 31, the respective width dimensions W, W2 of the annular protruding portion 32 and the annular groove portion 31, and the clearance C are the same as those in the illustrated first embodiment.

By setting the above-indicated clearance C to not greater than 1 mm or setting the width dimension W of the annular protruding portion 32 to not greater than 2 mm, the following advantage is assured: If the sheet P to be used is plain paper, the sheet P may get wet due to the ink attached thereto upon recording of images with high dot density such as photograph images, whereby the sheet P may suffer from low resiliency, namely, a low resistance force to the deflection. In the present arrangement, however, even if the sheet P suffers from such low resiliency, the feeding force for feeding the sheet P while being held by and between the sheet-discharge roller 28 and each spur roller 30 is not lowered, so that the sheet P can be fed with high reliability. Therefore, it is possible to avoid the occurrence of the banding. It is noted that, in this seventh embodiment, experimental results similar to those (FIG. 9) mentioned above with respect to the illustrated first embodiment are obtained. Namely, the relationships shown in the respective graphs of FIGS. 10-12 and explained with respect to the illustrated first embodiment apply to the seventh embodiment.

In this seventh embodiment described above, when the sheet P is not present between the sheet-discharge roller 28 and the spur rollers 30, each spur roller 30 is not biased toward the sheet-discharge roller 28 by the elastic shaft 37 and the radially outermost ends of the respective spurs 33 of each spur roller 30 are out of contact with any portion of the sheet-discharge roller 28. Therefore, the radially outermost projections 33b of each spur 33 are not likely to be worn as described above with respect to the illustrated first embodiment.

While the preferred embodiments of this invention have been described in detail by reference to the drawings, it is to be understood that the invention may be otherwise embodied.

The sheet-discharge roller 28 may be otherwise formed. For instance, a large-diameter portion is formed in the sheet-discharge roller 28 so as to face the circumferential surface of the intermediate hub 34 of each spur roller 30 and small-diameter portions having a diameter smaller than that of the large-diameter portion are formed respectively on axially opposite sides of the large-diameter portion so as to extend in the axial direction of the sheet-discharge roller 28.

In the illustrated embodiments, each spur roller 30 is configured to include two spurs 33 and one intermediate hub 34. The sheet feeding device according to the present invention may employ spur rollers each including at least three spurs and at least two intermediate hubs each of which is disposed between adjacent two spurs. In detail, as long as the sheet feeding device is arranged such that an annular protruding portion is provided on the sheet-feed roller so as to face an intermediate hub disposed between two of the at least three spurs and such that the two small-diameter portions are provided respectively on axially opposite sides of the annular protruding portion, such a sheet feeding device falls within the technical category of the present invention.

It is to be understood that the inventions may be embodied with various changes and modifications, which may occur to those skilled in the art, without departing from the spirit and scope of the inventions defined in the attached claims.

What is claimed is:

1. A sheet feeding device comprising:
a sheet-feed roller driven by a drive source; and
a spur roller which is opposed to a portion of the sheet-feed roller in an axial direction thereof and which is to be biased toward the sheet-feed roller, the spur roller and the sheet-feed roller cooperating with each other to feed a sheet while holding the sheet therebetween,
wherein the spur roller includes two spurs and an intermediate hub disposed between the two spurs for defining a distance therebetween and having an outside diameter smaller than that of each of the two spurs, and
wherein the sheet-feed roller includes: a large-diameter portion opposed to the intermediate hub so as to be interposable between respective radially outer portions of the two spurs; and two small-diameter portions which are respectively located on axially opposite sides of the large-diameter portion so as to extend beyond respective outer axial end faces of the two spurs and each of which has an outside diameter smaller than that of the large-diameter portion.

2. The sheet feeding device according to claim 1, wherein the spur roller is provided in a plural number so as to be spaced apart from each other in the axial direction of the sheet-feed roller and the large-diameter portion is provided in the plural number so as to be opposed respectively to the intermediate hubs of the respective spur rollers.

3. The sheet feeding device according to claim 1, further comprising an elastic member which biases the spur roller toward the sheet-feed roller.

4. The sheet feeding device according to claim 3, wherein the elastic member is an elastic shaft which rotatably supports the spur roller and which is permitted to be flexed.

5. The sheet feeding device according to claim 1, wherein the two small-diameter portions are two annular groove portions into which the respective two spurs are insertable.

6. The sheet feeding device according to claim 5, wherein the sheet feed roller includes two circumferential portions between which the two annular groove portions and the large-diameter portion are provided, the two circumferential portions having an outside diameter equal to that of the large-diameter portion.

7. The sheet feeding device according to claim 1, wherein a clearance between each of axial end faces of the large-diameter portion and each of axial inner end faces of the respective two spurs is not greater than 1 mm.

8. The sheet feeding device according to claim 7, wherein the large-diameter portion has a width dimension as measured in an axial direction thereof that is not greater than 2 mm.

9. The sheet feeding device according to claim 1, wherein the large-diameter portion has a circumferential surface that is formed into an axially convex curved surface whose outside diameter is larger than that of axial end faces of the large-diameter portion.

10. The sheet feeding device according to claim 1, wherein the large-diameter portion has rounded corner portions at each of which a circumferential surface and each of axial end faces of the large-diameter portion are connected.

11. The sheet feeding device according to claim 1, wherein the large-diameter portion has chamfered corner portions at each of which a circumferential surface and each of axial end faces of the large-diameter portion are connected.

12. The sheet feeding device according to claim 1, wherein the spur roller is formed as an integral unit constituted by including the two spurs and the intermediate hub.

13. The sheet feeding device according to claim 1, wherein radially outermost ends of the respective two spurs are out of contact with the respective two small-diameter portions.

14. The sheet feeding device according to claim 13, wherein axial inner end faces of the respective two spurs are out of contact with respective axial end faces of the large-diameter portion.

15. The sheet feeding device according to claim 13, wherein the spur roller is not biased toward the sheet feed roller when the sheet is not present therebetween.

16. The sheet feeding device according to claim 13, wherein when the sheet is not present between the sheet feed roller and the spur roller, a circumferential surface of the large-diameter portion makes contact with a circumferential surface of the intermediate hub.

17. The sheet feeding device according to claim 16, wherein the spur roller is biased toward the sheet feed roller when the sheet is not present therebetween.

18. The sheet feeding device according to claim 17, wherein the circumferential surface of the intermediate hub has a pair of inclined portions which are arranged to contact the circumferential surface of the large-diameter portion, each of the pair of inclined portions being formed such that its outside diameter gradually decreases from its axially outer end nearer to a corresponding one of the two spurs toward a middle of the two spurs.

19. The sheet feeding device according to claim 13,
wherein the two small-diameter portions are two annular groove portions into which the respective two spurs are insertable and the sheet feed roller includes two circumferential portions between which the two annular groove portions and the large-diameter portion are provided,
wherein the spur roller includes two side hubs between which the two spurs and the intermediate hub are provided, and
wherein when the sheet is not present between the sheet feed roller and the spur roller, circumferential surfaces of the respective two circumferential portions make contact with circumferential surfaces of the respective two side hubs.

20. The sheet feeding device according to claim 19, wherein the spur roller is biased toward the sheet feed roller when the sheet is not present therebetween.

21. The sheet feeding device according to claim 13, wherein a clearance between each of axial end faces of the large-diameter portion and each of axial inner end faces of the respective two spurs is not greater than 1 mm.

22. The sheet feeding device according to claim 21, wherein the large-diameter portion has a width dimension as measured in an axial direction thereof that is not greater than 2 mm.

23. An image recording apparatus, comprising:
an image recording unit of an ink-jet type for recording an image on a sheet to be fed; and
a sheet feeding device which is defined in claim 1 and which is disposed on a downstream side of the image recording unit as seen in a sheet feed direction in which the sheet is to be fed, for feeding the sheet in the sheet feed direction.
